(19) United States
(12) Patent Application Publication
(10) Pub. No.: US 2023/0237589 A1
(43) Pub. Date: Jul. 27, 2023

(54) MODEL OUTPUT CALIBRATION

(71) Applicant: INTUIT INC., Mountain View, CA (US)

(72) Inventors: Shirbi ISH-SHALOM, Orlando, FL (US); Hemeng TAO, Santa Clara, CA (US); Juan LIU, Cupertino, CA (US); Heather Elizabeth SIMPSON, Sunnyvale, CA (US); Sricharan Kallur Palli KUMAR, Fremont, CA (US)

(21) Appl. No.: 17/815,996

(22) Filed: Jul. 29, 2022

Related U.S. Application Data
(60) Provisional application No. 63/301,998, filed on Jan. 21, 2022.

(51) Int. Cl. G06Q 40/00

(52) U.S. Cl. CPC G06Q 40/123; G06N 20/00

(57) ABSTRACT

Aspects of the present disclosure provide techniques for confidence score calibration for automatic transaction categorization. Embodiments include providing one or more first inputs to a prediction model based on a transaction of a user. Embodiments include receiving a prediction of an account with a confidence score from the prediction model based on the one or more first inputs. Embodiments include providing one or more second inputs to a calibration model based on the confidence score, a detail type associated with the account, and a number of accounts of the user. Embodiments include receiving a calibrated confidence score from the calibration model based on the one or more second inputs. Embodiments include determining whether to automatically categorize the transaction into the account based on the calibrated confidence score.

### RELATED APPLICATIONS

This application claims the benefit of U.S. Provisional Application No. 63/301,998, entitled “MODEL OUTPUT CALIBRATION,” by the same inventors, filed 21 Jan. 2022, the contents of which are incorporated herein in their entirety.

### INTRODUCTION

Aspects of the present disclosure relate to techniques for automatic transaction categorization through confidence score calibration.

### BACKGROUND

Every year millions of people, businesses, and organizations around the world use electronic financial management systems, such as electronic accounting systems, to help manage their finances. Electronic accounting systems use accounts for categorization of business transactions. Such electronic accounting systems gather data related to financial transactions of the users. The users can then sort the financial transactions into the various accounts in order to track their expenditures and revenues by category. The users can monitor many or all of their financial transactions and other financial matters from a single electronic accounting system and sort them into the various financial accounts. Such an electronic accounting system can help users save time by eliminating the need to check with several different financial institutions in order to manage their finances.

During transaction categorization, transactions are categorized into different accounts in a chart of accounts. The chart of accounts includes multiple financial accounting accounts that are used in generating financial reports and understanding an entities' finances. In order to properly assess the entity's finances, transactions should be accurately categorized. In some cases, a chart of accounts includes multiple hierarchical levels, such as a detail type (or tax account) level and a sub-account (or managerial account) level.

Because of the number of transactions, computer systems assist by performing automated transaction categorization. In a computer, automated transaction categorization methods enhance user experience by reducing the need for tedious manual transaction review and categorization. However, conventional automated transaction categorization techniques often have limited accuracy, particularly when an entity is new and has few, if any, transactions categorized. For example, due to the general inability of conventional financial management systems to adequately understand the nature of the new user's accounts based solely on the names of the accounts, these systems will be unable to accurately perform automatic categorization of the user's transactions into the user's accounts. This is particularly problematic when the new user first attaches their accounts to the financial management system because during first use the number of transactions that a user must categorize is greatest. New users may be faced with many screens full of several months of transactions. Having to manually review and pick an account for each one discourages new users. Furthermore, during first use the relationship of a given user with the financial management system is most tenuous and the risk of customer abandonment is highest.

Certain existing techniques involve automated transaction categorization by associating a suitable category (e.g., customer account) with any given transaction. What is needed is a solution to differentiate category recommendations with a high level of confidence from those with a lower level of confidence so that a financial management system can automate the processing of the former to save users the effort of manually categorizing these transactions.

While there are existing techniques that involve the use of machine learning to predict categories of transactions, category recommendations output by such techniques may have limited accuracy in certain cases, particularly when a user is new to an electronic financial management system and has few, if any, transactions that have been previously categorized. For example, a model trained based on a plurality of users' historical transaction categorization data may not be finely tuned for a particular new user's chart of accounts (which may include unique account names that are difficult to correlate with account names in the charts of accounts of the plurality of users). Thus, while accounts determined using existing machine learning techniques may be used to provide recommended categorizations to a new user, they are rarely accurate enough to be used for automatically categorizing transactions.

What is needed is a solution for improved automated transaction categorization, particularly for users who are new to a financial management system.

### BRIEF SUMMARY

Certain embodiments provide a method for confidence score calibration for automatic transaction categorization. In one embodiment, a method includes: providing one or more first inputs to a prediction model based on a transaction of a user; receiving a prediction of an account with a confidence score from the prediction model based on the one or more first inputs; providing one or more second inputs to a calibration model based on the confidence score, a tax account associated with the account, and a number of accounts of the user; receiving a calibrated confidence score from the calibration model based on the one or more second inputs; and determining whether to automatically categorize the transaction into the account based on the calibrated confidence score.

Other embodiments provide a method for model output calibration. In one embodiment, the method comprises: providing one or more first inputs to a machine learning model; receiving an output from the machine learning model based on the one or more first inputs, wherein the output relates to a first entity; providing one or more second inputs to a calibration model based on the output from the machine learning model and based on a second entity that relates to the first entity; receiving a calibrated output from the calibration model based on the one or more second inputs, wherein the calibrated output relates to an accuracy of the output with respect to the second entity; and determining whether to perform one or more actions based on the calibrated output.

Other embodiments provide: an apparatus operable, configured, or otherwise adapted to perform the aforementioned method as well as those described elsewhere herein; a non-transitory, computer-readable media comprising instructions that, when executed by a processor of an apparatus, cause the apparatus to perform one or more of the aforementioned methods as well as those described elsewhere herein; a computer program product embodied on a computer-readable storage medium comprising code for performing one or more of the aforementioned methods as well as those described elsewhere herein; and an apparatus comprising means for performing one or more of the aforementioned methods as well as those described elsewhere herein. By way of example, an apparatus may comprise a processing system, a device with a processing system, or processing systems cooperating over one or more networks.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for automatic transaction categorization through confidence score calibration.

FIG. 2 is an illustration of an example of training a calibration model.

FIG. 3 is an illustration of an example of using a calibration model to improve automated transaction categorization.

FIG. 4A depicts example operations for automatic transaction categorization through confidence score calibration.

FIG. 4B depicts example operations for model output calibration.

FIGS. 5A and 5B depict example processing systems for automatic transaction categorization through confidence score calibration.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to automatic transaction categorization through confidence score calibration.

Embodiments described herein may utilize machine learning techniques to automatically categorize user transactions into user accounts (e.g., charts of accounts), such as for financial management purposes. In some cases, historical transaction categorization data of a plurality of users can be used to learn how certain types of transactions tend to be categorized.

For example, a machine learning model may be trained, based on historical transaction categorization data of a plurality of users, to output one or more recommended accounts from a user's chart of accounts in response to one or more inputs describing a transaction. The output from the machine learning model may include a confidence score indicating a likelihood that a given transaction corresponds to a given account. One example of such a machine learning model for automated categorization of transactions into user accounts is described in U.S. patent application Ser. No. 17/217,907, filed on Mar. 30, 2021, the contents of which are incorporated herein by reference in their entirety.

While existing machine learning techniques do provide a significant benefit, account recommendations output by such techniques may have limited accuracy in certain cases, particularly when a user is new to a financial management system and has few, if any, transactions that have been previously categorized. For example, a model trained based on a plurality of users' historical transaction categorization data may not be finely tuned for a particular new user's chart of accounts (which may include unique account names that are difficult to correlate with account names in the charts of accounts of the plurality of users). Thus, while accounts determined using existing machine learning techniques may be used to provide recommended categorizations to a new user, they are rarely accurate enough to be used for automatically categorizing transactions without manual review.

While existing machine learning techniques may not consistently produce recommended categorizations for a new user that are accurate enough to be used for automatically categorizing transactions at a “sub-account level”, accuracy at the sub-account level is not as important as accuracy at a legally significant level, such as a “detail type” level. A user's chart of accounts can be envisioned as a hierarchical structure with a top level that includes detail types and a lower level that includes sub-accounts within the detail types. A detail type is a high-level category that relates to compliance with tax laws and/or regulations, and is common across all users. For example, the detail type “utilities” is used for categorizing transactions when filing taxes, and has legal significance to a tax processing agency. Within the detail type “utilities,” an individual user may define sub-accounts such as “internet,” “electric,” “water,” “gas,” “phone service,” and/or the like, which do not have legal significance with respect to taxes, and are used for other financial management purposes. Different users may define different sub-accounts within the detail type “utilities,” but the detail type “utilities” is common to all users. It is noted that the particular detail types and sub-accounts described herein are included as non-limiting examples. Embodiments described herein may be beneficially implemented with any structure of chart of accounts.

To address issues with existing techniques, embodiments described herein involve calibrating confidence scores output by a first machine learning model (e.g., a model described above) based on a “detail type” (sometimes referred to as a “tax account type”) associated with an account to which the confidence score corresponds and based on a number of “sub-accounts” of a user to which the confidence score corresponds. While certain account predictions may not be accurate enough at the sub-account level for automatic categorization, many such predictions may have a higher likelihood of being accurate at the detail type level (which is more important). As such, by calibrating confidence scores output by a first machine learning model with respect to the sub-account level based on a detail type level using a second machine learning model (a calibration model), a larger amount of transactions may be automatically categorized.

According to certain embodiments, a second machine learning model is trained to output a calibrated confidence score in response to inputs that include a confidence score output by the first machine learning model, a number of sub-accounts of a user to which the confidence score corresponds, and a detail type of the account to which the confidence score corresponds. The second machine learning model may, for example, be a binary classification model that outputs a “calibrated” confidence score indicating a likelihood that the account recommendation output by the first model is accurate at the detail type level. The calibrated confidence score can be used to determine whether to automatically categorize the transaction according to the account recommendation output by the first model.

The fact that detail types are common across all users means that a first machine learning model trained on historical transaction categorization data from a plurality of users is more likely to be accurate at the detail type level than at the sub-account level when used for a given user, particularly a new user. Furthermore, the fewer sub-accounts a user has, the more likely an account recommendation is to be accurate at the detail type level. Thus, utilizing these additional data points to train a second machine learning model to calibrate a confidence score output by a first machine learning model produces a calibrated confidence score that is indicative of how likely it is that the output from the first machine learning model is accurate at the detail type level. In some embodiments, transactions may be automatically categorized into the account (e.g., which may be a sub-account) corresponding to the confidence score output by the first machine learning model if the calibrated confidence score output by the second machine learning model exceeds a threshold. Thus, techniques described herein allow a larger number of transactions to be automatically categorized by focusing on detail type level accuracy rather than sub-account level accuracy, thereby providing maximum automation while ensuring at least compliance with tax laws and/or regulations.

Embodiments of the present disclosure constitute a technical improvement with respect to conventional techniques for automatic transaction categorization. For example, by utilizing a calibration model to calibrate confidence scores output by a prediction model based on accuracy of account predictions at a detail type level, techniques described herein allow a potentially larger number of transactions to be automatically categorized while still ensuring compliance with laws and regulations. Furthermore, by training the calibration model based on additional data points related to transactions, such as a number of user accounts and a detail type of a predicted account, machine learning techniques described herein provide a more complete picture of prediction accuracy than conventional techniques (e.g., existing machine learning techniques that do not calibrate outputs from a model based on accuracy of predictions at a detail type level), particularly with respect to a detail type level. Allowing a larger number of transactions to be automatically categorized improves system efficiency, reduces the need for manual review of categorizations by users, improves display screen utilization by avoiding displaying transactions for categorization that can in fact be reliably categorized automatically, and the like.

Furthermore, by relying on detail type level accuracy (which is applicable across all users) rather than sub-account level accuracy (which is user-specific) in training the calibration model, techniques described herein allow training data to be more universally applicable across different users' charts of accounts, thereby increasing the amount of relevant training data for any given user and consequently improving model performance for all users.

### Example Computing Environment

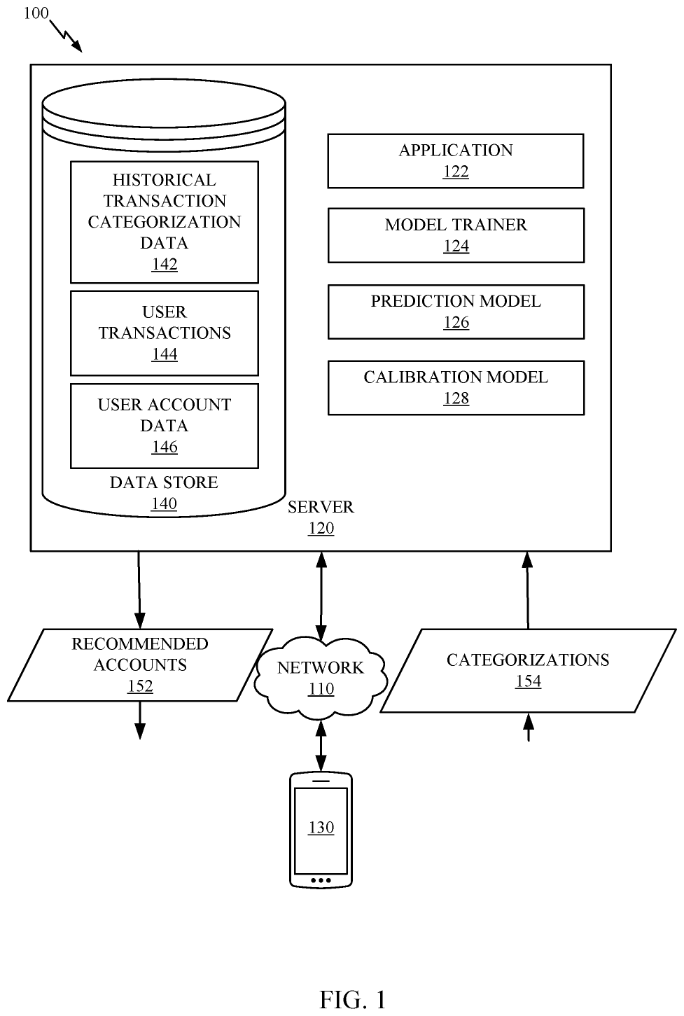

FIG. 1 illustrates an example computing environment 100 for automatic transaction categorization through confidence score calibration.

Computing environment 100 includes a server 120 and a client 130 connected over network 110. Network 110 may be representative of any type of connection over which data may be transmitted, such as a wide area network (WAN), local area network (LAN), cellular data network, and/or the like.

Server 120 includes an application 122, which generally represents a computing application that a user interacts with over network 110 via client 130. In some embodiments, application 122 is accessed via a user interface associated with client 130. In one example, application 122 comprises a financial management system that is configured to provide financial management services to a plurality of users.

According to one embodiment, application 122 is an electronic financial accounting system that assists users in book-keeping or other financial accounting practices. Additionally, or alternatively, the financial management system can manage one or more of tax return preparation, banking, investments, loans, credit cards, real estate investments, retirement planning, bill pay, and budgeting. Application 122 can be a standalone system that provides financial management services to users. Alternatively, the application 122 can be integrated into other software or service products provided by a service provider.

In one embodiment, application 122 can assist users in tracking expenditures and revenues by retrieving financial transaction data (e.g., user transactions 144) related to financial transactions of users and by enabling the users to sort the financial transactions into accounts (e.g., included in user account data 146). Each user can have multiple accounts into which the user's financial transactions can be sorted, which may be referred to as the user's “chart of accounts”. User account data 146 may include detail types associated with accounts (e.g., sub-accounts). Application 122 enables the users to generate and name their various accounts and to use the accounts for their own financial tracking purposes, such as tax preparation and filing.

Model trainer 124 uses historical transaction categorization data 142 to train prediction model 126, such as using supervised learning techniques. Machine-learning models allow computing systems to improve and refine functionality without explicitly being programmed. Given a set of training data, a machine-learning model can generate and refine a function that determines a target attribute value based on one or more input features.

In an example, historical transaction categorization data 142 includes records of categorizations of transactions into accounts that were historically performed by a plurality of users. Training data may be generated based on historical transaction categorization data 142, such as by associating features of transactions with labels indicating accounts into which the transactions were historically categorized (or, in some embodiments, attributes of the accounts). In some embodiments, training of prediction model 126 may be a supervised learning process that involves providing training inputs (e.g., features related to a transaction) as inputs to the model. The model processes the training inputs and outputs classifications (e.g., indicating whether the transaction represented by the features should be categorized into one or more accounts, along with confidence scores for the predictions) with respect to the training inputs. The outputs are compared to labels (e.g., known categorizations) associated with the training inputs to determine the accuracy of the model, and the model is iteratively adjusted until one or more conditions are met. Prediction model 126 may, for example, comprise one or more neural networks and/or tree-based classifiers. Neural networks generally include a collection of connected units or nodes called artificial neurons, which loosely model the neurons in a biological brain. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network.

In some cases, recommended accounts 152 may be provided to client device 130 based on the predictions output by prediction model 126, and/or categorizations 154 may be received from client device 130, such as indicating categorizations of transactions into accounts (e.g., which may in some embodiments be based on recommended accounts 152). The categorizations 154 by the user of the transactions into user accounts (e.g., included in user account data 146) are used (e.g., along with categorizations performed by a plurality of other users, such as included in historical transaction categorization data 142) to generate training data, which may be used by model trainer 124 to train calibration model 128.

Calibration model 128 may, for example, be a binary classifier. In one example, calibration model 128 is a random forest model. In another example, calibration model 128 is an XGBoost model. A tree model (e.g., a decision tree) makes a classification by dividing the inputs into smaller classifications (at nodes), which result in an ultimate classification at a leaf. A random forest extends the concept of a decision tree model, except the nodes included in any give decision tree within the forest are selected with some randomness. Thus, random forests may reduce bias and group outcomes based upon the most likely positive responses. Boosting, or gradient boosting, is a method for optimizing tree models. Boosting involves building a model of trees in a stage-wise fashion, optimizing an arbitrary differentiable loss function. In particular, boosting combines weak “learners” into a single strong learner in an iterative fashion. A weak learner generally refers to a classifier that chooses a threshold for one feature and splits the data on that threshold, is trained on that specific feature, and generally is only slightly correlated with the true classification (e.g., being at least more accurate than random guessing). A strong learner is a classifier that is arbitrarily well-correlated with the true classification, which may be achieved through a process that combines multiple weak learners in a manner that optimizes an arbitrary differentiable loss function. The process for generating a strong learner may involve a majority vote of weak learners. An XGBoost model is an example of a gradient boosted model.

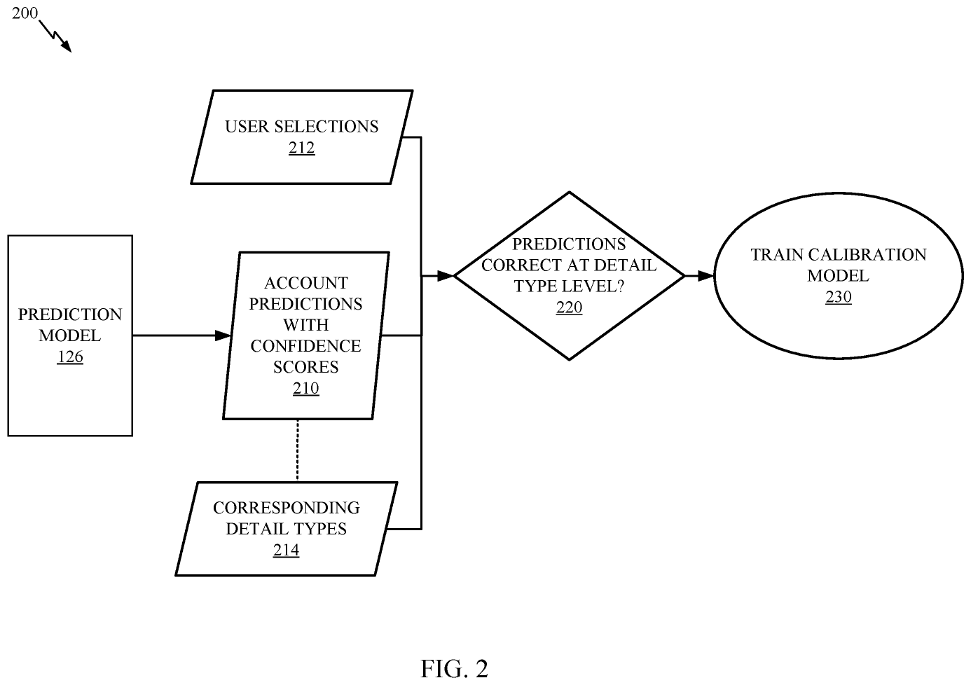

Training of calibration model 128 is described in more detail below with respect to FIG. 2.

Once trained, calibration model 128 may accept as inputs a confidence score output by prediction model 126 (e.g., in association with an account prediction for a transaction), a detail type associated with the account to which the confidence score corresponds, and a number of accounts of the user to which the confidence score corresponds. Calibration model 128 may output a calibrated confidence score based on the inputs, the calibrated confidence score indicating a confidence that the prediction made by prediction model 126 is accurate at the detail type level. The calibrated confidence score may be used to determine whether to automatically categorize the transaction into an account predicted by prediction model 126, such as based on whether the calibrated confidence score exceeds a threshold. The threshold may be set to a variety of different values, such as to optimize the amount of automatic categorizations while minimizing the amount of categorizations that are inaccurate at the detail type level.

Data store 140 generally represents a data storage entity such as a database or repository that stores historical transaction categorization data 142, user transactions 144, and user account data 146. Historical transaction categorization data 142 generally includes records of categorizations of transactions into accounts by a plurality of users of application 122. User transactions 144 include the transactions of one or more users (e.g., the user of client 130), which may be received (e.g., downloaded from one or more sources) at the time a given user first uses application 122. User account data 146 includes users' charts of accounts, which also may be received (e.g., via user input) at the time a given user first uses application 122. A user's chart of accounts may include detail types and sub-accounts. User transactions 144 and user account data 146 may be updated over time as new transactions and new accounts are received for a given user. Similarly, historical transaction categorization data 142 may be updated over time as categorizations 154 are received from users.

Client 130 generally represents a computing device such as a mobile phone, laptop or desktop computer, tablet computer, or the like. Client 130 is used to access application 122 over network 110, such as via a user interface associated with client 130. In alternative embodiments, application 122 (and, in some embodiments model trainer 124, prediction model 126, calibration model 128, and/or data store 140) is located directly on client 130 or on one or more separate devices.

### Example Training of a Calibration Model

FIG. 2 is an illustration 200 of an example of training a calibration model, such as calibration model 128 of FIG. 1. Illustration 200 includes prediction model 126 of FIG. 1.

Prediction model 126 outputs account predictions with confidence scores 210, such as based on input features related to transactions of users, and relate to accounts in the users' charts of accounts. Account predictions with confidence scores 210 may include, for a given transaction of a given user, a set of confidence scores indicating likelihoods that the given transaction should be categorized into each account in the given user's chart of accounts. The confidence scores may be normalized values between 0 and 1.

User selections 212 comprise records of user categorizations of the transactions into accounts. For example, user selections 212 may indicate whether each transaction associated with account predictions with confidence scores 210 was in fact categorized into the recommended account, or at least the same detail type as the recommended account.

Corresponding detail types 214 comprise the detail types of the accounts indicated in account predictions with confidence scores 210.

Account predictions with confidence scores 210, user selections 212, and corresponding detail types 214 are used at step 220 to determine whether the predictions are correct at the detail type level. In one example, if a given user selection 212 indicates that a given transaction was in fact categorized by a given user into the predicted account or at least into another account with the same detail type as the predicted account, then that prediction is used as a positive training data instance (e.g., associated with a label of “1” or “true”). On the other hand, if a given user selection 212 indicates that a given transaction was not in fact categorized by a given user into the predicted account or even into another account with the same detail type as the predicted account, then that prediction is used as a negative training data instance (e.g., associated with a label of “0” or “false”). In some embodiments, one or more third parties such as accounting experts may review the user categorizations and/or the predictions to confirm whether or not the predictions were accurate, and the labels (e.g., true or false) may be also or alternatively be based on the third party review.

At step 230, the calibration model is trained based on whether the predictions were determined to be correct at the detail type level at step 220. For example, the positive and negative training data instances (e.g., including confidence scores, detail types, and numbers of user accounts associated with labels of true or false) may be used to iteratively adjust parameters of the calibration model until one or more conditions are met.

For example, with reference to FIG. 1, calibration model 128 may be trained based on accuracy of predictions made by model trainer 124 at the detail type level. Training data instances may include, as training inputs, confidence scores output by prediction model 126 (e.g., in association with account predictions for transactions), detail types associated with the accounts to which the confidence scores correspond, and numbers of accounts of the users to which the confidence scores correspond. Labels of the training data instances may include indicators of whether the account predictions were accurate at the detail type level, such as based on whether users in fact categorized the transactions into the detail types associated with the accounts predicted by prediction model 126 and/or based on third party review, such as by one or more accounting experts (e.g., to account for the possibility of user error and thereby improve the reliability of the training data).

In some embodiments, training calibration model 128 involves providing training inputs to calibration model 128. Calibration model 128 processes the training inputs and outputs confidence scores indicating a confidence that the predictions represented by the training inputs are accurate at the detail type level. The outputs are compared to the labels associated with the training inputs to determine the accuracy of calibration model 128, and parameters of calibration model 128 are iteratively adjusted until one or more conditions are met.

For example, the conditions may relate to whether the predictions produced by calibration model 128 based on the training inputs match the labels associated with the training inputs or whether a measure of error between training iterations is not decreasing or not decreasing more than a threshold amount. The conditions may also include whether a training interaction limit has been reached. Parameters adjusted during training may include, for example, hyperparameters, values related to numbers of iterations, weights, functions, and the like. In some embodiments, validation and testing are also performed for calibration model 128, such as based on validation data and test data, as is known in the art. Calibration model 128 may be trained either through batch training (e.g., each time a threshold number of training data instances have been generated) or through online training (e.g., re-training calibration model 128 with each new training data instance as it is generated). Thus, calibration model 128 may be continuously improved through re-training as new categorizations are received from users.

### Example of Using a Calibration Model to Determine a Calibrated Confidence Score

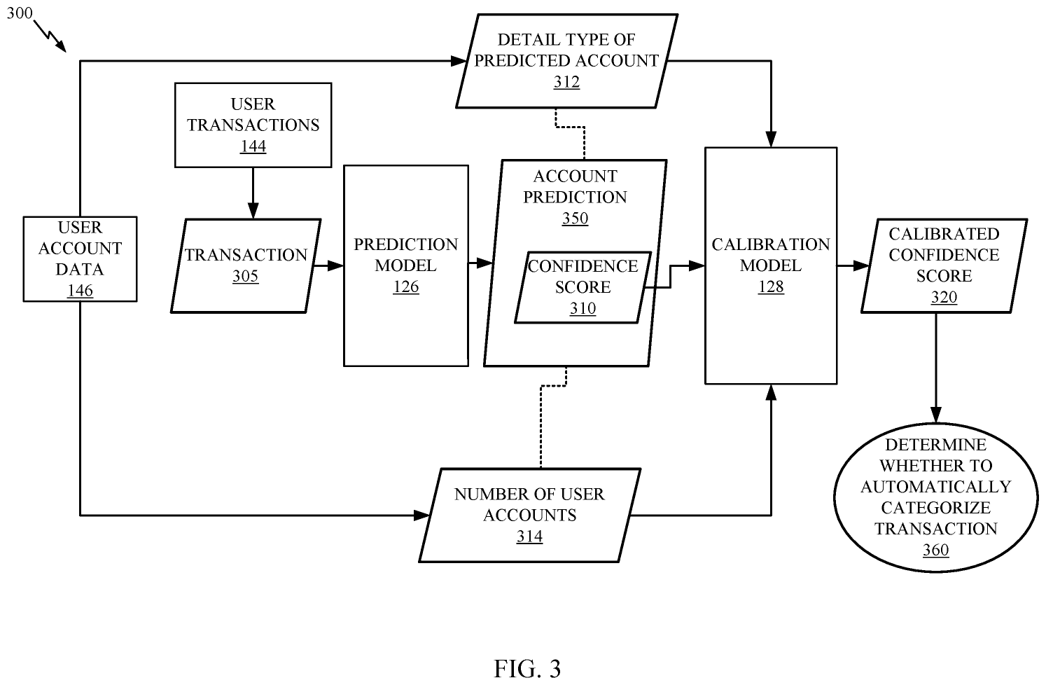

FIG. 3 is an illustration 300 of an example of using a calibration model to improve automated transaction categorization. Illustration 300 includes prediction model 126, calibration model 128, user account data 146, and user transactions 144 of FIG. 1.

One or more inputs are provided to prediction model 126 based on a transaction 305 from user transactions 144. For example, the one or more inputs may be features describing the transaction. In some embodiments, a list of the user's accounts is also provided to prediction model 126.

Prediction model 126 outputs an account prediction 350, including a confidence score 310 for a predicted account.

While conventional techniques may involve simply recommending the predicted account output by a machine learning model to a user without any additional processing, embodiments of the present disclosure overcome inaccuracies associated with such techniques through the use of a calibration model. For example, a detail type 312 of the predicted account is determined (e.g., based on user account data 146). Furthermore, a number 314 of accounts of the user is determined (e.g., based on user account data 146).

Confidence score 310, detail type 312, and number 314 of user accounts are provided as inputs to calibration model 128 (e.g., which may have been trained as described above with respect to FIGS. 1 and 2). In some embodiments, detail type 312 is provided to calibration model 128 in the form of a one-hot encoded vector that includes binary values representing all possible detail types (which may be a fixed set across all users). The binary value representing the detail type of the predicted account may be set to “1” while all of the binary values representing other detail types may be set to “0”. This is included as an example, and other techniques for providing inputs to calibration model 128 may be used.

Calibration model 128 outputs a calibrated confidence score 320 based on the inputs. Calibrated confidence score 320 indicates a confidence that the account prediction 350 output by prediction model 126 is accurate at the detail type level.

Calibrated confidence score 320 may then be used at step 360 to determine whether to automatically categorize transaction 305 into the predicted account, such as based on whether calibrated confidence score 320 exceeds a threshold.

In a particular example, prediction model 126 predicts transaction categories (at the account level, which may be a sub-account level), and is trained on a global dataset, which may be curated based on input from experts. The relative confidence of the prediction is defined by a confidence score for each transaction with a prediction. For example, prediction model 126 may predict the sub-account for a users' bank transactions along with a confidence score (e.g., normalized within a range from 0 to 1) that gives a confidence of the model predictions.

Calibration model 128 is trained to generate a new calibrated confidence score that is representative of detail type level accuracy, which may be beneficial when considering tax compliance. As such, the next step for training calibration model 128 is to map the sub-account predicted by prediction model 126 to its corresponding detail type and determine whether the prediction is correct based on user selections. For example, if the user went on to categorize the transaction into the sub-account predicted by prediction model 126 or another sub-account within the corresponding detail type, then the prediction is determined to be correct. On the other hand, it the user did not categorize the transaction into the sub-account predicted by prediction model 126 or another sub-account within the corresponding detail type, then the prediction is determined not to be correct. In some embodiments, user categorizations are also reviewed by one or more third parties, such as accounting experts, to confirm the accuracy or inaccuracy of the predictions (e.g., in order to account for the possibility of user error). For example, an accounting professional may determine that a user categorization was incorrect, and the label for a corresponding training data instance may be adjusted accordingly.

Calibration model 128 may be trained based on a set of predictions from prediction model 126 along with indications of whether the predictions were correct at the detail type level (e.g., based on user categorizations and/or third party review) and, in some embodiments, additional data points such as the number of sub-accounts of users associated with the predictions and the specific detail types associated with the predictions. Calibration model 128 may be a binary classifier that outputs predictions and confidence scores at the detail type level, thereby allowing the predictions output by prediction model 126 to be aligned with detail type level accuracy.

It is noted that, while embodiments are described herein with respect to particular types of machine learning models and particular types of predictions (e.g., account predictions for transactions), techniques described herein may also be employed in other contexts. For example, techniques described herein involve receiving outputs from a first machine learning model that relate to one entity (e.g., a lower hierarchical level) and training a second machine learning model to calibrate the outputs from the first machine learning model with respect to a second entity that relates to the first entity (e.g., based on a different measure of accuracy, such as with respect to a higher hierarchical level than that represented by the outputs from the first machine learning model). As such, embodiments described herein with respect to account predictions for transactions and accuracy measures such as sub-account and detail type levels are included as examples, and the underlying techniques may be employed for other types of model outputs and with other types of entities and/or measures of accuracy. In such embodiments, accounts or sub-accounts may be replaced with various types of entities and detail types may be replaced with other (e.g., higher level or other related) types of entities. A number of user accounts may, for example, be replaced with a number of lower-level entities within one or more higher-level types of entities as an input to a calibration model.

For instance, a calibration model may be trained to calibrate outputs relating to a particular user received from a prediction model based on accuracy of the outputs with respect to a category of users that includes the user or with respect to a different individual user. In another example, a calibration model may be trained to calibrate outputs relating to a particular locality (e.g., city) received from a prediction model based on accuracy of the outputs with respect to a higher-level locality (e.g., state or country) or with respect to a different locality. In yet another example, calibration model may be trained to calibrate outputs relating to a particular type of data received from a prediction model based on accuracy of the outputs with respect to a category of the type of data or with respect to a different type of data. These are included as examples, and other embodiments are possible.

In one particular example, a first machine learning model outputs a recommended type of content to provide to a particular user based on features related to the user. User feedback may then be gathered with respect to the particular user and/or other users that are grouped with the particular user (e.g., based on shared attributes) and/or a different particular user, such as relating to whether the particular user, other users in the group, or the other particular user interacted with the recommended type of content or other types of content. In an example, if a certain percentage of users in the group interacted with the recommended type of content, the output from the first machine learning model may be determined to be accurate at the group level. The user feedback may be used to train a second machine learning model to output an indication of whether a given output from the first machine learning model is accurate with respect to the group or with respect to the other particular user. For instance, an output from the first machine learning model with respect to a given user may be provided along with additional inputs such as an identifier of the group to which the given user belongs and a number of users (e.g., in the group or across all groups) as one or more inputs to the second machine learning model, and the second machine learning model may output an indication of whether the output from the first machine learning model is accurate at the group level (e.g., in the form of a calibrated confidence score or another type of output).

Confidence scores are included as an example, and other types of model outputs may also be used. For example, other measures of accuracy may alternatively be used, such as binary indicators of accuracy, categories of accuracy (e.g., low, medium, high), among others. In one example, a prediction model outputs an indication that a particular type of content (e.g., a complaint regarding a particular product) is present in text, and a calibration model is trained to accept that indication as an input, along with a category of the type of content (e.g., a category of products) and output an indication of whether the output from the first model is accurate with respect to the category of the type of content (e.g., yes or no, and/or some other measure of accuracy).

Certain embodiments involve the use of confidence scores to guide a workflow of transaction categorization such that transactions with high-confidence account predictions are automatically categorized, bypassing manual review, whereas transactions with low-confidence account predictions are sent to a workflow where more user attention is requested.

It is noted that “detail type” may be alternatively referred to as “tax account” and “sub-account” may alternatively be referred to as “managerial account.” The terms detail type and sub-account are non-limiting, and generally refer to a first hierarchical level in a chart of accounts (e.g., that relates to a legal or regulatory domain such as taxes) and a second hierarchical level in the chart of accounts (e.g., that relates to a personal or business domain such as management) that may be lower in the hierarchy than the first hierarchical level.

### Example Operations for Automatic Transaction Categorization Through Confidence Score Calibration

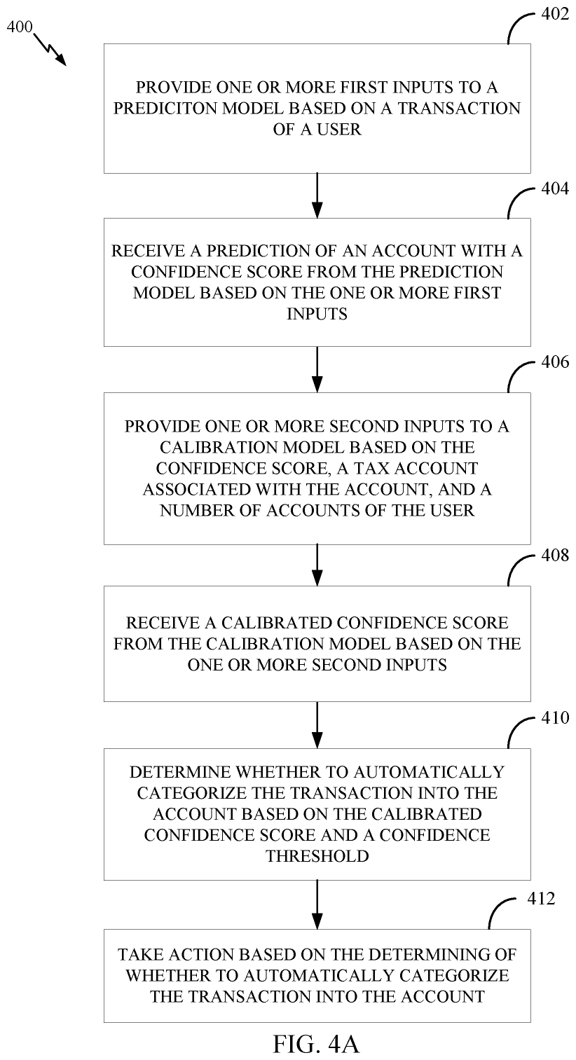

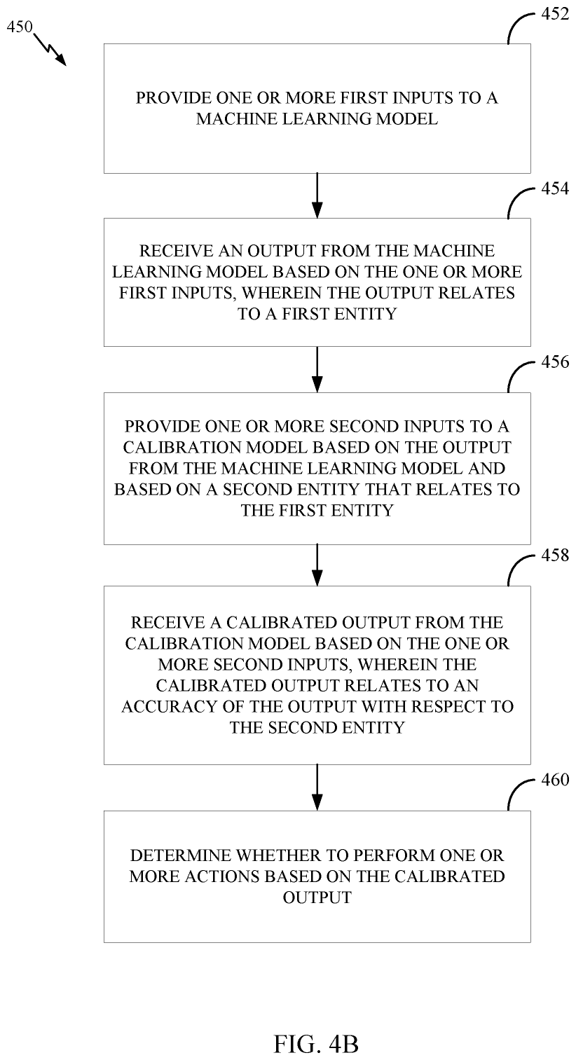

FIG. 4A depicts example operations 400 for automatic transaction categorization through confidence score calibration. For example, operations 400 may be performed by one or more components of server 120 and/or client 130 of FIG. 1.

Operations 400 begin at step 402, with providing one or more first inputs to a prediction model based on a transaction of a user.

Operations 400 continue at step 404, with receiving a prediction of an account with a confidence score from the prediction model based on the one or more first inputs.

Operations 400 continue at step 406, with providing one or more second inputs to a calibration model based on the confidence score, a tax account associated with the account, and a number of accounts of the user. In other embodiments, the number of accounts of the user is not used when providing inputs to the calibration model.

Operations 400 continue at step 408, with receiving a calibrated confidence score from the calibration model based on the one or more second inputs.

Operations 400 continue at step 410, with determining whether to automatically categorize the transaction into the account based on the calibrated confidence score and a confidence threshold value.

Operations 400 continue at step 412, with taking action based on the determining whether to automatically categorize the transaction into the account. For example, the action may include automatically categorizing the transaction into the account (e.g., if the calibrated confidence score exceeds the confidence value threshold) or proving a recommendation of categorizing the transaction into the account for manual review (e.g., if the calibrated confidence score does not exceed the confidence value threshold). In certain embodiments, the action may involve discarding the prediction and neither recommending nor automatically performing categorization of the transaction into the account, such as if the calibrated confidence score is below a threshold. In certain cases, the calibration model and/or the prediction model may be retrained based on user feedback, such as based on whether the user manually categorizes the transaction into the account or into another account and/or based on third party review, such as by an expert. In some embodiments, an alert may be generated if the calibrated confidence score falls below a threshold, or is a threshold amount higher or lower than the confidence score output by the prediction model.

In some embodiments, the account comprises a sub-account or managerial account associated with the tax account in a chart of accounts of the user.

### Example Operations for Model Output Calibration

FIG. 4B depicts example operations 450 for model calibration. For example, operations 400 may be performed by one or more components of server 120 and/or client 130 of FIG. 1 and/or one or more other components.

Operations 450 begin at step 452, with providing one or more first inputs to a machine learning model.

Operations 450 continue at step 454, with receiving an output from the machine learning model based on the one or more first inputs, wherein the output relates to a first entity.

Operations 450 continue at step 456, with providing one or more second inputs to a calibration model based on the output from the machine learning model and based on a second entity that relates to the first entity. The second entity may, for example, be a higher-level entity that encompasses the first entity or may be a lower-level entity encompassed by the first entity. In another example, the second entity shares one or more attributes with the second entity.

Operations 450 continue at step 458, with receiving a calibrated output from the calibration model based on the one or more second inputs, wherein the calibrated output relates to an accuracy of the output with respect to the second entity. For example, the calibration model may have been trained based on ground truth data indicating accuracies of outputs from the machine learning model with respect to the second entity.

Operations 450 continue at step 460, with determining whether to perform one or more actions based on the calibrated output. The actions may include, for example, performing an action that the output from the machine learning model suggests is beneficial.

Some embodiments further comprise automatically performing an action based on the output if the calibrated output exceeds a threshold and/or generating a recommendation based on the output if the calibrated output does not exceed a threshold. Certain embodiments further comprise discarding the output if the calibrated output is below a threshold. In some cases, user input related to the first entity or the second entity may be received, and may be used to generate updated training data for re-training the calibration model. In certain embodiments, the updated training data is further based on feedback from one or more third parties.

### Example Computing System

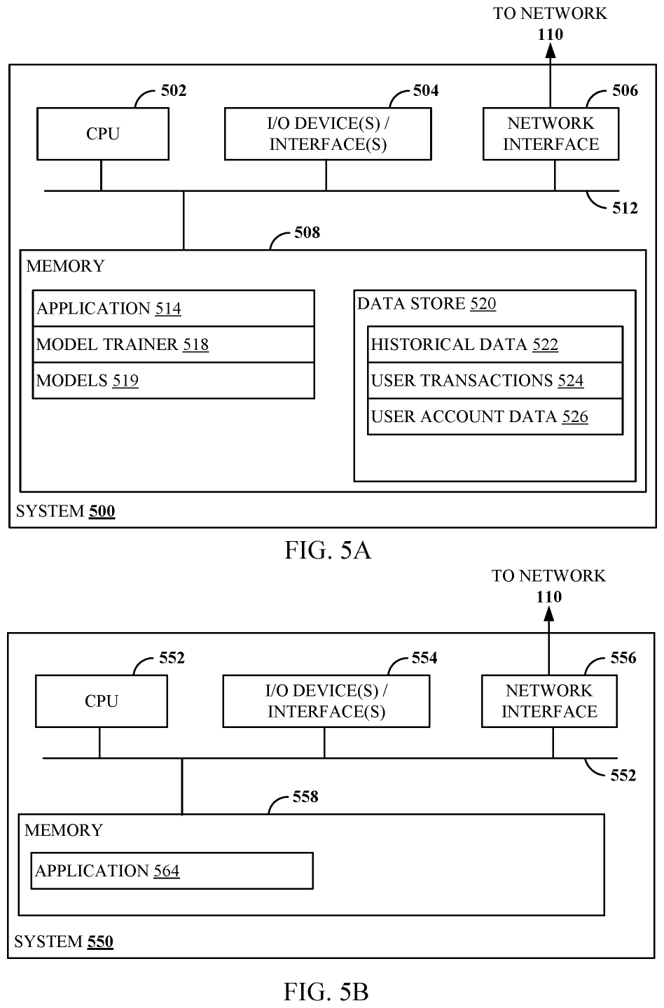

FIG. 5A illustrates an example system 500 with which embodiments of the present disclosure may be implemented. For example, system 500 may be representative of server 120 of FIG. 1.

System 500 includes a central processing unit (CPU) 502, one or more I/O device interfaces 504 that may allow for the connection of various I/O devices 514 (e.g., keyboards, displays, mouse devices, pen input, etc.) to the system 500, network interface 506, a memory 508, and an interconnect 512. It is contemplated that one or more components of system 500 may be located remotely and accessed via a network. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes application 514, model trainer 518, and models 519, which may be representative of application 122, model trainer 124, prediction model 126, and calibration model 128 of FIG. 1. Memory 508 further comprises data store 520, which may be representative of data store 140 of FIG. 1. While data store 520 is depicted in local storage of system 500, it is noted that data store 520 may also be located remotely (e.g., at a location accessible over a network, such as the Internet). Data store 520 includes historical data 522, user transactions 524, and user account data 526, which may be representative of historical transaction categorization data 142, user transactions 144, and user account data 146 of FIG. 1.

FIG. 5B illustrates another example system 550 with which embodiments of the present disclosure may be implemented. For example, system 550 may be representative of client 130 of FIG. 1.

System 550 includes a central processing unit (CPU) 552, one or more I/O device interfaces 554 that may allow for the connection of various I/O devices 554 (e.g., keyboards, displays, mouse devices, pen input, etc.) to the system 550, network interface 556, a memory 558, and an interconnect 552. It is contemplated that one or more components of system 550 may be located remotely and accessed via a network. It is further contemplated that one or more components of system 550 may comprise physical components or virtualized components.

CPU 552 may retrieve and execute programming instructions stored in the memory 558. Similarly, the CPU 552 may retrieve and store application data residing in the memory 558. The interconnect 552 transmits programming instructions and application data, among the CPU 552, I/O device interface 554, network interface 556, and memory 658. CPU 552 is included to be representative of a single CPU, multiple CPUs, a single CPU having multiple processing cores, and other arrangements.

Additionally, the memory 558 is included to be representative of a random access memory. In some embodiments, memory 558 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 558 includes an application 564, which may be representative of a client-side component corresponding to the server-side application 514 of FIG. 5A. For example, application 564 may comprise a user interface through which a user of system 550 interacts with application 514 of FIG. 5A. In alternative embodiments, application 514 is a standalone application that performs behavior prediction as described herein.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for confidence score calibration for automatic transaction categorization, comprising:
providing one or more first inputs to a prediction model based on a transaction of a user;
receiving a prediction of an account with a confidence score from the prediction model based on the one or more first inputs;
providing one or more second inputs to a calibration model based on the confidence score, a tax account associated with the account, and a number of accounts of the user;
receiving a calibrated confidence score from the calibration model based on the one or more second inputs; and
determining whether to automatically categorize the transaction into the account based on the calibrated confidence score.

2. The method of claim 1, further comprising automatically categorizing the transaction into the account if the calibrated confidence score exceeds a threshold.

3. The method of claim 1, further comprising generating a recommendation to categorize the transaction into the account if the calibrated confidence score does not exceed a threshold.

4. The method of claim 1, further comprising discarding the prediction if the calibrated confidence score is below a threshold.

5. The method of claim 1, further comprising:
receiving user input categorizing the transaction into a given account; and
generating updated training data for re-training the calibration model based on the user input.

6. The method of claim 5, wherein the updated training data is further based on feedback from one or more third parties.

7. The method of claim 1, wherein the account is a managerial associated with the tax account in a chart of accounts of the user.

8. A method for model output calibration, comprising:
providing one or more first inputs to a machine learning model;
receiving an output from the machine learning model based on the one or more first inputs, wherein the output relates to a first entity;
providing one or more second inputs to a calibration model based on the output from the machine learning model and based on a second entity that relates to the first entity;
receiving a calibrated output from the calibration model based on the one or more second inputs, wherein the calibrated output relates to an accuracy of the output with respect to the second entity; and
determining whether to perform one or more actions based on the calibrated output.

9. The method of claim 8, further comprising automatically performing an action based on the output if the calibrated output exceeds a threshold.

10. The method of claim 8, further comprising generating a recommendation based on the output if the calibrated output does not exceed a threshold.

11. The method of claim 8, further comprising discarding the output if the calibrated output is below a threshold.

12. The method of claim 8, further comprising:
receiving user input related to the first entity or the second entity; and
generating updated training data for re-training the calibration model based on the user input.

13. The method of claim 12, wherein the updated training data is further based on feedback from one or more third parties.

14. A system, comprising:
one or more processors; and
a memory comprising instructions that, when executed by the one or more processors, cause the system to:
provide one or more first inputs to a prediction model based on a transaction of a user;
receive a prediction of an account with a confidence score from the prediction model based on the one or more first inputs;
provide one or more second inputs to a calibration model based on the confidence score, a tax account associated with the account, and a number of accounts of the user;
receive a calibrated confidence score from the calibration model based on the one or more second inputs; and
determine whether to automatically categorize the transaction into the account based on the calibrated confidence score.

15. The system of claim 14, wherein the instructions, when executed by the one or more processors, further cause the system to automatically categorize the transaction into the account if the calibrated confidence score exceeds a threshold.

16. The system of claim 14, wherein the instructions, when executed by the one or more processors, further cause the system to generate a recommendation to categorize the transaction into the account if the calibrated confidence score does not exceed a threshold.

17. The system of claim 14, wherein the instructions, when executed by the one or more processors, further cause the system to discard the prediction if the calibrated confidence score is below a threshold.

18. The system of claim 14, wherein the instructions, when executed by the one or more processors, further cause the system to:
receive user input categorizing the transaction into a given account; and
generate updated training data for re-training the calibration model based on the user input.

19. The system of claim 18, wherein the updated training data is further based on feedback from one or more third parties.

20. The system of claim 14, wherein the account is a managerial associated with the tax account in a chart of accounts of the user.
